(19) United States
(12) Patent Application Publication
(10) Pub. No.: US 2026/0172347 A1
(43) Pub. Date: Jun. 18, 2026

(54) INTER VIRTUAL ROUTER FORWARDING WITH FIREWALL INTELLIGENCE

(71) Applicant: Palo Alto Networks, Inc., Santa Clara, CA (US)

(72) Inventors: Sameer Kumar, Cupertino, CA (US); Apoorv Bhargava, Hayward, CA (US); Jason Baucom, Elk Grove, CA (US)

(21) Appl. No.: 18/982,950

(22) Filed: Dec. 16, 2024

(51) Int. Cl. H04L 45/586; H04L 9/40; H04L 45/745; H04L 61/2521

(52) U.S. Cl. CPC H04L 45/586; H04L 45/745; H04L 61/2535; H04L 63/02; H04L 63/04

(57) ABSTRACT

The present application discloses a method, system, and computer system for routing network traffic to be sent through a firewall, the network traffic being routed to the appropriate client when the firewall services clients having overlapping IP addresses. The method includes: (a) storing an ingress Virtual Routing and Forwarding (VRF) information in connection with a client-server flow information for a particular session, and (b) causing network traffic received from a server to be routed based at least in part on the VRF information.

### BACKGROUND OF THE INVENTION

In modern network environments, there is an increasing demand for flexible, scalable, and secure traffic management, particularly in software-defined wide area network (SD-WAN) deployments. Enterprises frequently implement network segmentation using virtual routing and forwarding (VRF) instances, which enable the use of the same IP address space across different client segments. This segmentation is particularly useful in managed network environments, where clients may require unique security policies, network controls, and segregated data flows.

### BRIEF DESCRIPTION OF THE DRAWINGS

Various embodiments of the invention are disclosed in the following detailed description and the accompanying drawings.

FIG. 1 is a block diagram of an environment for performing inter-virtual router forwarding according to various embodiments.

FIG. 2 is a block diagram of an environment for performing inter-virtual router forwarding according to various embodiments.

FIG. 3 is an example of routing information for inter-virtual router forwarding according to various embodiments.

FIG. 4 is a flow diagram of a method for routing traffic according to various embodiments.

FIG. 5 is a flow diagram of a method for routing inbound network traffic from a server in connection with a server-to-client flow according to various embodiments.

FIG. 6 is a flow diagram of a method for routing network traffic received from a client in connection with a client-to-server flow according to various embodiments.

FIG. 7 is a flow diagram of a method for storing virtual router forwarding information in connection with received network traffic according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A common challenge arises when clients segmented using virtual routing and forwarding access shared resources, such as the internet, through a common network security device like a Next-Generation Firewall (NGFW). Managing overlapping IP addresses while maintaining unique session tracking, security policy enforcement, and traffic routing per client segment is a complex task. Existing solutions often require separate, costly physical or logical resources to manage each segment, which is not always practical or efficient for scalable deployments.

Various embodiments provide a method, system, and computer system for routing network traffic to be sent through a firewall, the network traffic being routed to the appropriate client when the firewall services clients having overlapping IP addresses. The method includes: (a) storing an ingress virtual routing and forwarding (VRF) information in connection with a client-server flow information for a particular session, and (b) causing network traffic received from a server to be routed based at least in part on the VRF information.

In conventional network security and routing systems, VRF instances are commonly used to achieve logical network segregation, enabling clients to have isolated access to resources while sharing underlying physical infrastructure. This approach is especially valuable in enterprise environments, data centers, and managed networks, where multiple clients or tenants may require distinct routing domains for privacy, security, or policy-based management. Typically, inter-virtual router forwarding (inter VRF) involves configuring route-leak to allow traffic between the virtual routers. If multiple VRF clients with same IPs want to access an Internet VRF, related art systems are unable to support this through standard routing.

In traditional systems, VRFs supported by network security devices, such as firewalls, are typically configured to prevent overlapping IP address spaces among different VRFs. This restriction exists because most conventional firewalls identify and manage traffic flows based on IP addresses, which are assumed to be unique across the system. When multiple clients require the same IP address ranges (e.g., 10.0.0.0/24) within different VRFs, the firewall cannot reliably distinguish between these clients, as there is no mechanism to isolate traffic uniquely based on the VRF context.

This limitation in conventional systems forces network administrators to either assign globally unique IP address spaces to each VRF, which can be impractical or costly in large-scale deployments, or deploy separate physical or virtual firewalls for each VRF, significantly increasing infrastructure and management costs. As a result, existing solutions lack flexibility and scalability, particularly for managed SD-WAN environments where clients or tenants may require both isolated address spaces and shared internet access through a unified firewall.

The need for flexible network design is particularly pronounced in SD-WAN deployments, where organizations want to maintain efficient, secure internet access for clients while enforcing both network and security segregation. Without the ability to handle overlapping IP address spaces across VRFs, administrators face a significant challenge in meeting these requirements, especially when multiple tenants or clients need consistent address configurations that may not be globally unique.

Therefore, there is a need for an improved system that supports overlapping IP address spaces among VRFs in a way that enables secure, scalable, and efficient traffic management within shared network security devices like next-generation firewalls (NGFWs). Such a system would allow VRFs to coexist with overlapping address spaces while maintaining the firewall's ability to enforce security policies and track sessions independently for each client.

According to various embodiments the system stores the ingress VRF in association with the client-to-server (C2S) flow, and when server sends the return traffic (e.g., when the system receives the return traffic from the server), the system bypasses the route lookup in the internet VRF based on the implementation of the route lookup in the ingress VRF information obtained from session lookup. In some embodiments, the system implements unique routing information for C2S traffic and/or S2C traffic. The system can store unique routing information for C2S traffic based at least in part on ensuring flows in a given virtual-router (VR) has a corresponding zone. For example, each VR is assigned a unique virtual router identifier, and the system stores a mapping between session identifiers and corresponding virtual router identifiers (e.g., for the VRs through which clients are accessing the network to obtain service from the server) for each particular session. The system can store unique routing information S2C traffic unique based at least in part on implementing source network address translation (SRC NAT) when traffic is egressed over the internet. The system can implement these techniques in connection with an SDWAN hub multi-VR and SDWAN branch muti-VR.

Various embodiments implement book-keeping performed at the firewall (e.g., a next generation firewall) to maintain C2S and S2C flows. The system can support overlapping IP address spaces across VRs by extending the book-keeping maintained at the firewall to include storing routing information based on existing firewall constructs like zones (e.g., virtual router ingress interface identifiers) and network address translation (NAT).

Various embodiments provide a method for implementing Inter VRF and/or a network security system that comprises a plurality of VRFs that enable overlapping IP address spaces across different clients (e.g., two clients from accessing the network via different VRs can have the same IP address). The system, which may be implemented within a NGFW or similar device, supports network traffic segregation and enforces security policies for each VRF while managing C2S and S2C flows uniquely and securely.

According to various embodiments, for C2S flows, the system identifies each flow based on an identifier associated with the VRF (e.g., a unique zone identifier associated with the ingress interface for the VRF) from which the traffic is received. This VRF identifier is stored in the session information, ensuring each client flow can be managed independently, even when IP addresses overlap among clients.

According to various embodiments, for S2C flows, the system utilizes source network address translation (NAT) upon egressing traffic over the internet. It performs a lookup to determine an address and port associated with the VRF corresponding to the C2S flow. This enables accurate routing of S2C flows back to the correct VRF and client, ensuring proper session continuity and secure data flow management.

In SD-WAN scenarios, various embodiments enable network operators to implement both network and security segregation effectively. Network operators can place clients in separate VRFs, thereby reusing IP address spaces, while providing them internet access through a unified NGFW. Ad

This system is particularly suitable for SD-WAN deployments where multiple clients, potentially with overlapping IP address requirements, access the internet through a shared NGFW. It enables pure network segregation while maintaining unified internet access, providing significant cost and efficiency benefits over traditional network architecture.

### Advanced or Next Generation Firewalls

Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks. Unfortunately, as techniques are developed to help detect and mitigate malware, nefarious authors find ways to circumvent such efforts. Accordingly, there is an ongoing need for improvements to techniques for identifying and mitigating malware.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices, and in some implementations, certain operations can be implemented in special purpose hardware, such as an ASIC or FPGA).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as described herein). A firewall can also filter local network (e.g., intranet) traffic by similarly applying a set of rules or policies.

Security devices (e.g., security appliances, security gateways, security services, and/or other security devices) can perform various security operations (e.g., firewall, anti-malware, intrusion prevention/detection, proxy, and/or other security functions), networking functions (e.g., routing, Quality of Service (QoS), workload balancing of network related resources, and/or other networking functions), and/or other security and/or networking related operations. For example, routing can be performed based on source information (e.g., IP address and port), destination information (e.g., IP address and port), and protocol information (e.g., layer-3 IP-based routing).

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls).

For example, Palo Alto Networks' next generation firewalls enable enterprises to identify and control applications, users, and content-not just ports, IP addresses, and packets-using various identification technologies, such as the following: App-ID for accurate application identification, User-ID for user identification (e.g., by user or user group), and Content-ID for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

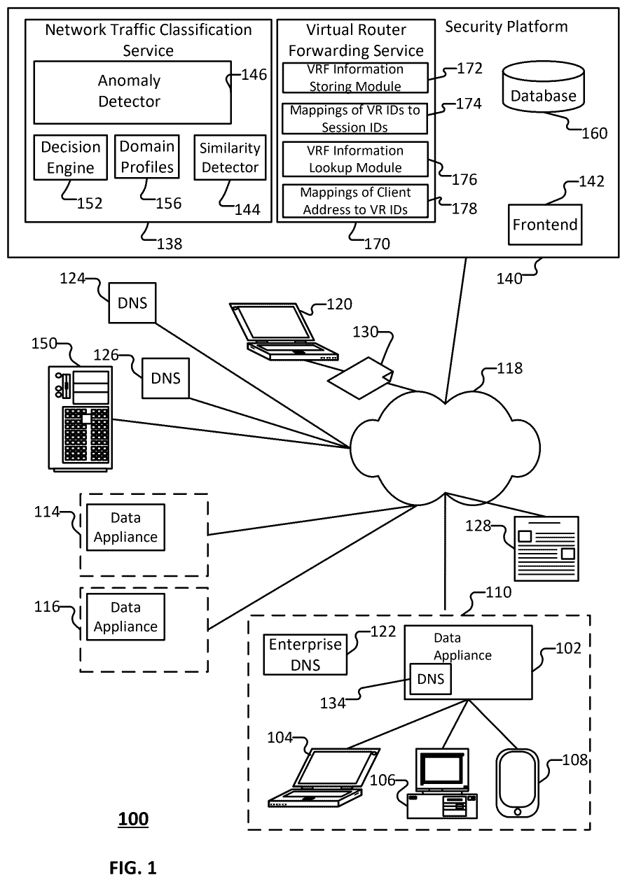

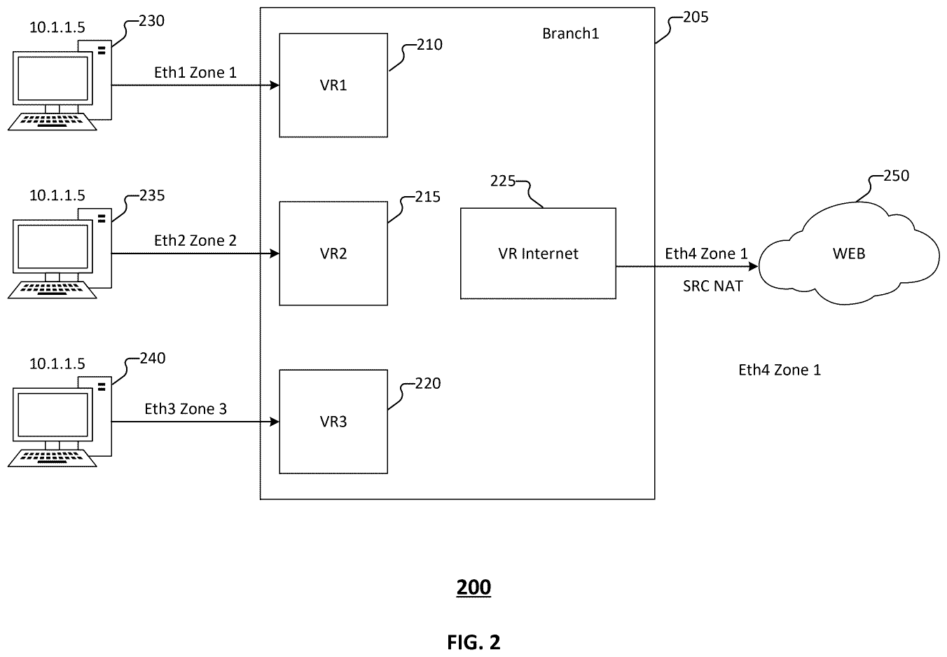

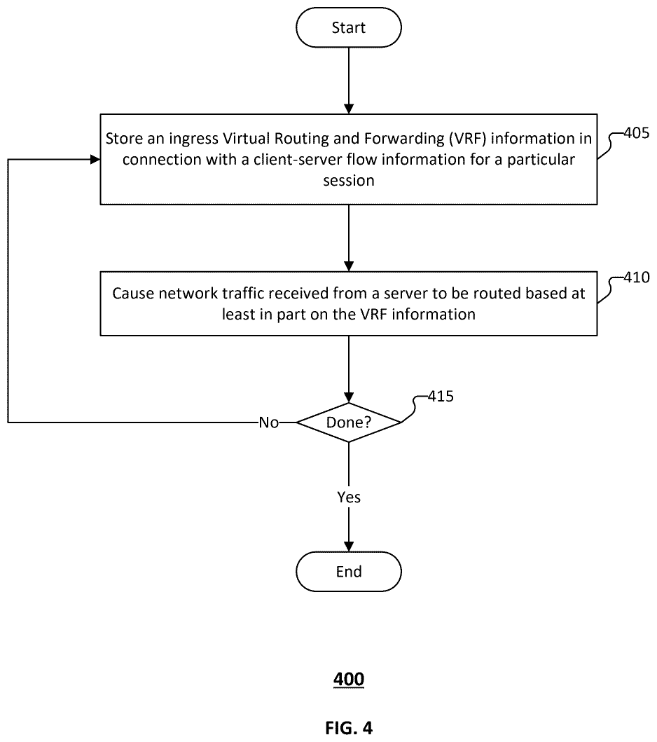

FIG. 1 is a block diagram of an environment for performing inter-virtual router forwarding according to various embodiments. In some embodiments, system 100 implements at least part of system 200 of FIG. 2. System 100 can implement one or more of processes 400-700 of FIGS. 4-7.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110. In some embodiments, data appliance 102 is a network edge device. For example, data appliance 102 can implement ION device functionality, security services (e.g., firewall functionality), etc.

Techniques described herein can be used in conjunction with a variety of platforms (e.g., desktops, mobile devices, gaming platforms, embedded systems, etc.) and/or a variety of types of applications (e.g., Android .ask files, iOS applications, Windows PE files, Adobe Acrobat PDF files, Microsoft Windows PE installers, etc.). In the example environment shown in FIG. 1, client devices 104-108 are endpoints, such as a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including classifying domains (e.g., predicting whether a domain is a malicious domain, etc.), classifying DNS response records (e.g., predicting whether a domain IP pair in a DNS response is a DNS hijacked record, etc.), classifying network traffic, providing a mapping of signatures to certain domains or DNS records (e.g., a DNS record for which a predicted likelihood that the record is a DNS hijacked record exceeds a predefined likelihood threshold, etc. a mapping of domains or DNS records to domain or DNS record data (e.g., domain certificates, pen's data, active DNS data, WHOIS data, etc.), performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that a domain is malicious (e.g., a DNS hijacked record) or benign (e.g., not DNS hijacked), providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign), receive risk signals (e.g., a signal pertaining to an endpoint risk for a network) from one or more other services or products, aggregate a set of risk signals (e.g., to obtain an aggregate risk score or to classify an endpoint), collecting network traffic information (e.g., comprising IP addresses, device information, etc.), determining IP-to-device mappings, filtering the IP-to-device mappings (e.g., for a particular network edge to identify a filtered set of IP-to-device mappings relevant to the particular network edge), distributing to various network edge devices (e.g., data appliance 102) the filtered set of IP-to-device mappings relevant to the various network edge devices, distributing (e.g., to various network edge devices) policies to be enforced at the network edge(s), etc.

In some embodiments, inter VRF is implemented at data appliance 102. For example, data appliance 102 can store the ingress VRF information in connection with a C2S flow information for a particular session. As another example, data appliance 102 causes the network traffic received from a server to be routed based at least in part on the VRF information.

In some embodiments, inter VRF is implemented at security platform 140. For example, security platform 140 can store the ingress VRF information in connection with a C2S flow information for a particular session. As another example, security platform 140 causes the network traffic received from a server to be routed based at least in part on the VRF information. For example, data appliance 102 may be a VR and security platform 140 supports a plurality of VRs, including data appliance 102.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware Six, Citrix eServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises/implements network traffic classification service 138 and/or virtual router forwarding service 170. Security platform 140 may include various other services/modules, such as a malicious file detector, a malicious traffic detector, a parked domain detector, a DNS hijacked domain or DNS record detector, a DNS traffic classifier, an application classifier or other traffic classifier, etc.

Network traffic classification service 138 is used in connection with analyzing network traffic (e.g., websites, domains, sample files, etc. pertaining to the network traffic) and/or automatically detecting malicious network traffic.

Virtual router forwarding service 170 is used in connection with routing network traffic, such as S2C flows. In some embodiments, virtual router forwarding service 170 supports a plurality of VRs, a plurality of which may have at least partially overlapping IP address spaces. Virtual router forwarding service 170 can properly route network traffic to the appropriate client in systems where a plurality of clients have the same IP address such as in the case when the clients connect to the network via different virtual routers supported by virtual router forwarding service 170.

In some embodiments, virtual router forwarding service 170 comprises one or more of VRF information storing module 172, mappings of VR IDs to session IDs 174, VRF information lookup module 176, and/or mappings of client address to VR IDs 178.

Virtual router forwarding service 170 uses VRF information storing module 172 to store routing information for ingress C2S traffic. In some embodiments, VRF information storing module 172 stores information to map a particular VR to a session. For example, VRF information storing module 172 obtains an indication that a new session has been established and that traffic has been received via a VR (e.g., ingress traffic from a client connected to a network via a VR). VRF information storing module 172 stores an identifier associated with the VR (e.g., a VR identifier, such as a VR-ID, an ingress interface identifier, etc.) in association with an identifier for the particular session (e.g., session identifier). In some embodiments, VRF information storing module 172 stores the routing information (e.g., an indication that a particular VR is associated with a particular session) in mappings of VR IDs to session IDs 174. Mappings of VR IDs to session IDs 174 may be stored in database 160.

In some embodiments, VRF information storing module 172 additionally stores routing information for a VR, such as a routing table that maps client identifiers to IP addresses for the IP address space associated with the VR. In some embodiments, VRF information storing module 172 stores the routing information (e.g., an indication of an IP address for a client connected to the network via a particular VR) in mappings of client address to VR IDs 178. Mappings of client address to VR IDs 178 may be stored in database 160.

Virtual router forwarding service 170 uses VRF information lookup module 176 to determine a routing for network traffic, such as ingress S2C traffic (e.g., S2C traffic responsive to a particular C2S flow) and to provide the routing, such as in connection with causing the network traffic to be properly routed to the applicable client. In response to receiving an indication that ingress S2C traffic is to be routed, VRF information lookup module 176 can perform a lookup for the VR associated with the particular session corresponding to the S2C traffic. For example, the S2C traffic may carry a session identifier and VRF information lookup module 176 uses the session identifier in connection with performing a lookup against mappings of VR IDs to session IDs 174 to obtain the VR identifier associated with the particular session. In response to determining the VR identifier associated with the particular session, the appropriate client address can be determined (e.g., obtained) based on the routing table for the VR. For example, the system can use the VR identifier associated with the particular session to perform a lookup in the mapping of client addresses to VR IDs to obtain the address for the client. Accordingly, the system can route the S2C traffic based on routing the traffic through the appropriate VR to the applicable client.

Network traffic classification service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, DNS traffic is malicious or whether a DNS record is DNS hijacked), domain profiles 156, and/or a similarity detector 144. In some embodiments, network traffic classification service 138 detects malicious network traffic or malware obtained from intercepted network traffic (e.g., by classifying a file sample obtained by a security entity or other network node requesting a maliciousness classification).

Network traffic classification service 138 can determine the classification for network traffic (e.g., a file sample obtained from network traffic, a DNS record, a DNS query, a DNS response, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process. Examples of machine learning processes that can be implemented in connection with training the classifier(s) include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc. In some embodiments, the classifier implements a CNN.

According to various embodiments, security platform 140 may receive a query from a security entity (e.g., inline firewall, such as a next generation firewall) for a real-time or offline classification of a network traffic sample, such as a file.

According to various embodiments, in response to network traffic classification service 138 classifying the network traffic sample, system 100 handles the corresponding network traffic according to a predefined policy (e.g., a security policy). For example, in response to predicting that the network traffic sample corresponds to malicious network traffic, system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to network traffic classification service 138 classifying the network traffic (e.g., the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains or having certain characteristics/profiles is to be blocked and network traffic associated with other domains or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed network traffic sample for a particular session), security platform 140 (e.g., network traffic classification service 138) sends an indication that network activity (e.g., other network traffic samples) associated with the session for which the network traffic sample is obtained are associated with, or otherwise correspond to, the determined classification. In the case that the determined classification for the network traffic sample is that the corresponding network sample (e.g., a file extracted from the network traffic) or network traffic/activity is malicious network traffic/activity, security platform 140 provides an indication that network traffic/activity associated with the session for which the network traffic sample is obtained is also to be handled according to whether the network traffic sample is malicious. Security platform 140 can provide an indication that network traffic matching the network traffic sample predicted to be malicious is to be handled as a malicious network traffic. For example, security platform 140 determines (e.g., computes) a signature or identifier for the network traffic/activity (e.g., a hash or other signature, or identifier for the corresponding network session), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, in response to determining the maliciousness classification for a network traffic sample (e.g., obtaining the predicted maliciousness classification, such as from a classifier), network traffic classification service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

DNS hijacked domains, for example, can be domains that are scams, phishing sites, or sites used to distribute C2 exploits or malware.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within enterprise network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of an environment for performing inter-virtual router forwarding according to various embodiments. In some embodiments, system 200 is implemented at least in part by system 100. System 200 may implement at least part of one or more of processes 400-700 of FIGS. 4-7.

In the example shown, system 200 comprises a routing entity 205 that handles C2S traffic and S2C traffic. Routing entity 205 that is configured to route traffic from one or more clients to the internet (e.g., a server via the internet) and to route traffic received from the internet (e.g., from a server providing a service via the internet) to the appropriate client behind (e.g., connected to) the routing entity 205. In some embodiments, routing entity 205 is a firewall such as a next generation firewall. As an example, routing entity 205 corresponds to a branch (e.g., branch 1).

According to various embodiments, routing entity 205 is configured to run a plurality of virtual routing instances. In the example shown, routing entity 205 supports three virtual routers: VR1 210, VR2 215, and VR3 220. The various virtual routers can comprise interfaces (e.g., ingress interfaces) that are associated with different zones, for example, an ingress interface of VR1 210 is associated with zone 1, an ingress interface of VR2 215 is associated with zone 2, and an ingress interface of VR3 220 is associated with zone 3. However, in various embodiments, routing entity 205 can support various other numbers of virtual routers. The IP address spaces for two or more of the virtual routers supported by routing entity 205 can be at least partially overlapping. As illustrated in FIG. 2, each of VR1 210, VR2 215, and VR3 220 have an IP address 10.1.1.5 in their respective IP address spaces. For example, client 230 connects to the network via VR1 210, client 235 connects to the network via VR2 215, and client 240 connects to the network via VR3 220. Each of client 230, client 235, and client 240 have an IP address of 10.1.1.5 when connecting to their respective virtual routers.

Routing entity 205 (or specifically, an applicable virtual router) stores a mapping of clients connected through a particular virtual router and the corresponding addresses for the clients. For example, the mapping may comprise an indication of an IP address for the client and/or port via which the client connects to the virtual router. The system may also store a mapping of virtual routers to corresponding clients (e.g., a mapping of virtual router identifiers to client identifiers) to store an indication of the particular virtual router via which a particular client is connected to the system.

In some embodiments, in response to routing entity 205 (or specifically, an applicable virtual router) receiving C2S traffic from a client connected via a virtual router, the system (e.g., routing entity or the particular virtual router via which the client connected to the network) determines session associated with the C2S traffic, for example, by determining (e.g., obtaining) a session identifier for the particular session. Routing entity 205 stores, in association with the session identifier, an indication of a virtual router via which the C2S traffic was received. Thus, routing entity 205 can maintain a mapping of sessions to VRs, which can then be used in conjunction with the client address at the VR (e.g., according to a routing table for the VR) to route the return traffic.

As an illustrative example, traffic from client 230 ingresses via VR1 210. VR1 210 has the identifier zone 1 (e.g., the ingress interface identifier mapped to zone 1), and thus the session for the communication between client 230 and VR1 210 is mapped to the VR1 210 identifier (e.g., the ingress interface for zone 1). Routing entity 205 stores the VR1 210 identifier (e.g., the ingress interface for zone 1) in association with the session identifier for the session for which client 230 communicates with VR1 210. This association is used to denote that return traffic for that particular session is to be routed through VR 1 210. Similarly, traffic from client 235 ingresses via VR2 215. VR2 215 has the identifier zone 2 (e.g., the ingress interface identifier mapped to zone 2), and thus the session for the communication between client 235 and VR2 215 is mapped to the VR2 215 identifier (e.g., the ingress interface for zone 2). Traffic from client 240 ingresses via VR3 220. VR3 220 has the identifier zone 3 (e.g., the ingress interface identifier mapped to zone 3), and thus the session for the communication between client 240 and VR3 220 is mapped to the VR3 220 identifier (e.g., the ingress interface for zone 3).

According to various embodiments, the system uses the stored association between session identifier and VR identifier to differentiate traffic for different VRs.

Routing entity 205 egresses the C2S traffic to route the C2S traffic to the intended destination. In some embodiments, routing entity 205 implements VR 225 to interface (e.g. communicate) with the internet. In connection with egressing the C2S traffic via VR 225, the system (e.g., routing entity 205 and/or VR 225) can perform SRC NAT, for example, to replace the source address that denoted the client via which the C2S originated or the VR via which the client connected to the network with the address of VR 225 (or routing entity 205, generally). In response to performing the SRC NAT, VR 225 egresses the C2S traffic to the appropriate destination via internet 250.

According to various embodiments, routing entity 205 routes ingress S2C traffic based at least in part on the mappings of session identifier to VR identifiers. Using the example shown, routing entity 205 receives S2C traffic from the internet 250 (e.g., from a server providing a service via internet 250) via VR 225. For example, because of the SRC NAT performed when egressing the C2S traffic, the return S2C traffic has a destination location associated with VR 235. In response to receiving the ingress S2C traffic, the system (e.g., routing entity 205) determines the session with which the S2C traffic is associated. For example, the routing entity 205 obtains (e.g., extracts) a session identifier from the S2C traffic. In response to obtaining the session identifier, the system (e.g., routing entity 205) can use the session identifier to perform a lookup against the mapping of session identifiers to VR identifiers to determine (e.g., obtain) the VR identifier associated with the particular session. In the example shown, for S2C traffic that is return traffic for the C2S traffic communicated by client 230, routing entity 205 performs a lookup based on the session identifier obtained from the S2C traffic and determines that the particular session is mapped to VR1 210. Thus, routing entity 205 routes the S2C return traffic to VR1 210. The system (e.g., VR1 210 and/or routing entity 205) can then determine the particular destination address to which to route the S2C return traffic based at least in part on the session identifier. For example, the system uses the session identifier to perform a lookup against the routing table for VR1 210 and determines that the destination for the particular session is client 230 (e.g., IP address 10.1.1.5). VR1 210 then routes the traffic to client 230.

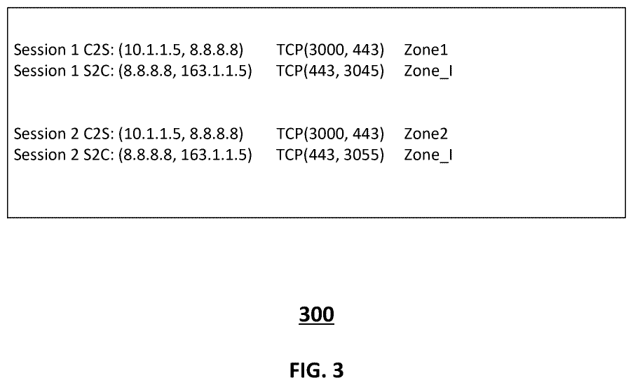

FIG. 3 is an example of routing information for inter-virtual router forwarding according to various embodiments. The example shown illustrates routing information 300 for various sessions. This routing information can be used in connection with determining the appropriate routing for C2S and S2C traffic flow based on the session information.

The routing information includes IP address information, comprising a source IP address and a destination IP address. The routing information for the C2S further include port information, comprising a source port and a destination port. In some embodiments, the system uniquely identifies C2S traffic based on the zone information (e.g., a zone identifier) stored in association with the session (e.g., Zone 1 in the case of session 1 in the illustrated example). The system uniquely identifies the S2C traffic based at least in part on the port number. The system determines the port for the VR via which the traffic is to be forwarded, and then uses the routing tables/information for the particular port/VR serviced by the port/VR to determine the client address associated with the session.

In some embodiments, traffic to the firewall becomes unique because the various VRs are expected to be different. Each VR has different interfaces (e.g., different ports through which traffic flows). According to various embodiments, the ingress interface in different VRs have unique zones in case any two VRs have overlapping IP address spaces. Each zone can have unique ports at the VRs. For example, there is no overlap in interfaces between VRs with respect to VRs of different zones. Because zone information (e.g., zone identifiers) can be used to identify a zone with which traffic is associated (e.g., the zone via which C2S traffic ingresses the firewall), the system can support overlapping IP address spaces (e.g., overlapping subnets). Therefore, clients from two different VRs (e.g., zones) can have the same IP address, and the ports/interfaces through which traffic flows through the firewall is used to distinguish between these two clients to appropriately route the information.

According to various embodiments, whichever interface (e.g., port corresponding to a VR) via which a packet enters, the zone information (e.g., zone identifier) for the interface is stored as part of the session. When the C2S traffic is egressed the port via which the traffic ingresses to the routing service is changed to a common port (e.g., port 3000 for zone_I in the illustrated example) so that internet traffic comes from the same internet port (e.g., the servers return the traffic to a destination address for the common port). However, as shown in the example, for return S2C traffic, the destination port used is not the common port 3000. Rather, the destination port used for the return S2C traffic is the port associated with the zone from which the corresponding C2S traffic flowed. In the example shown, port 3045 corresponds to zone 1 and port 3055 corresponds to zone 2. The system (e.g., the firewall) can make this common port to zone-specific port translation when receiving the S2C traffic and determining the routing for the S2C traffic flow.

In the example shown, session 1 comprises routing information for C2S traffic flow. The source IP address for the C2S traffic is 10.1.1.5 and the destination IP address (e.g., the address for the server) is 8.8.8.8. For session 1 the source port is 3000 and the destination port is 443. The destination port 443 in the C2S traffic corresponds to a common port for the routing service (e.g., the common port for a hub site). The routing service uses the common port to egress C2S traffic to the appropriate internet destination (e.g., the server) and translates this to the zone-specific port when return S2C traffic is received.

FIG. 4 is a flow diagram of a method for routing traffic according to various embodiments. In some embodiments, process 400 is implemented at least in part by system 100 of FIG. 1 and/or system 200 of FIG. 2.

At 405, the system stores an ingress VRF information in connection with a client-server flow information for a particular session. For example, the system stores a virtual router identifier in association with the particular session (e.g., in a mappings of session identifiers to virtual router identifiers. The association between the virtual router identifier and the particular session is used to denote the virtual router (e.g., corresponding to the virtual router identifier for the particular session) via which return traffic (e.g., S2C traffic) is to be routed.

At 410, the system causes the network traffic received from a server to be routed based at least in part on the VRF information. For example, the system provides an indication of the virtual router via which the network traffic is to be routed. The system may additionally provide an indication of the destination address for the particular client to which the network traffic is to be routed. The destination address for the particular client can be determined based on performing a lookup using the session identifier, for example, by performing a lookup in a mappings of session identifiers to client identifiers (which can then be used to determine the destination address from a routing table for the applicable virtual router) or a mappings of session identifiers to source addresses (e.g., the address for the client). As another example, causing the network traffic to be routed based at least in part on the VRF information includes determining the virtual router associated with the session for which the network traffic corresponds, determining the address for the client connected to the virtual router, and routing the network traffic via the virtual router to the client.

At 415, a determination is made as to whether process 400 is complete. In some embodiments, process 400 is determined to be complete in response to a determination that no further network traffic is to be routed/handled, an administrator indicates that process 400 is to be paused or stopped, etc. In response to a determination that process 400 is complete, process 400 ends. In response to a determination that 400 is not complete, process 400 returns to 405.

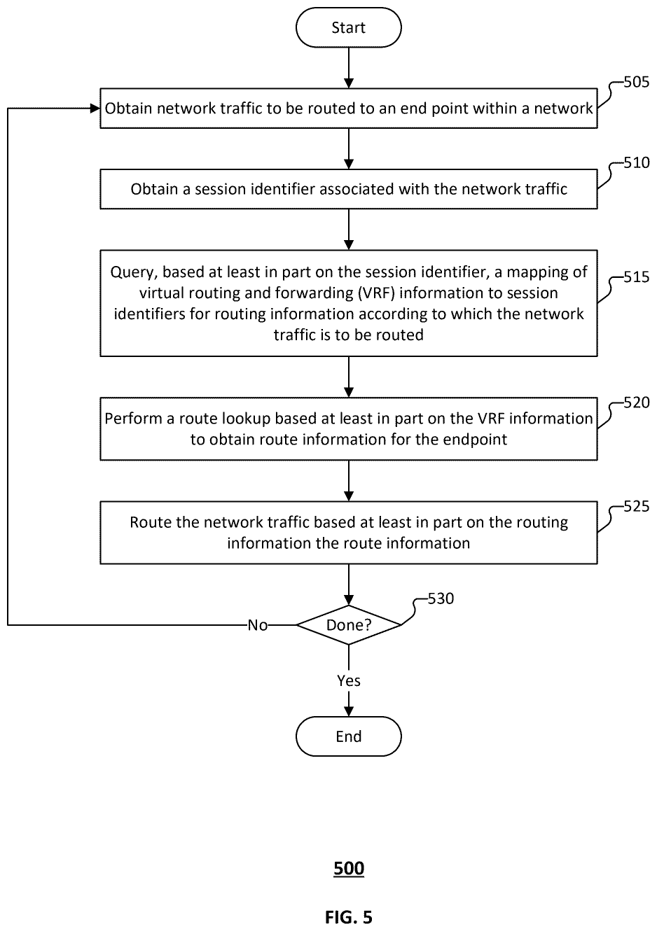

FIG. 5 is a flow diagram of a method for routing inbound network traffic from a server in connection with a server-to-client flow according to various embodiments. In some embodiments, process 500 is implemented at least in part by system 100 of FIG. 1 and/or system 200 of FIG. 2.

At 505, the system obtains the network traffic to be routed to an end point within a network (e.g., a client system connected to a network, such as behind a particular virtual router). The network traffic may be S2C traffic (e.g., return traffic for a particular C2S flow associated with a particular session). At 510, the system obtains a session identifier associated with the network traffic. At 515, the system queries, based at least in part on the session identifier, a mapping of VRF information to session identifiers for routing information according to the which the network traffic is to be routed. At 520, the system performs a route lookup based at least in part on the VRF information to obtain route information for the endpoint. For example, after determining the particular virtual router via which the network traffic is to be routed, the system can determine the address for the endpoint associated with the particular session. At 525, the system routes the network traffic based at least in part on the routing information. For example, the system uses the virtual router identifier and the end point address behind the virtual router to route the network traffic. At 530, a determination is made as to whether process 500 is complete. In some embodiments, process 500 is determined to be complete in response to a determination that no further network traffic is to be routed/handled, an administrator indicates that process 500 is to be paused or stopped, etc. In response to a determination that process 500 is complete, process 500 ends. In response to a determination that process 500 is not complete, process 500 returns to 505.

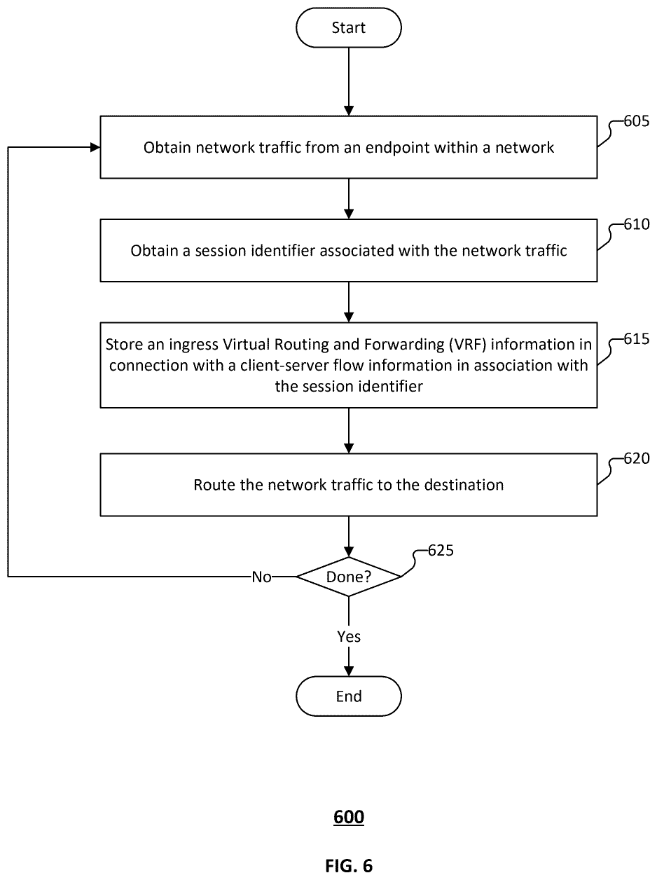

FIG. 6 is a flow diagram of a method for routing network traffic received from a client in connection with a client-to-server flow according to various embodiments. In some embodiments, process 600 is implemented at least in part by system 100 of FIG. 1, system 200 of FIG. 2, and/or system 300 of FIG. 3.

At 605, the system obtains network traffic from an endpoint within a network. At 610, the system obtains a session identifier associated with the network traffic. At 615, the system stores an ingress VRF information in connection with a client-server flow (e.g., C2S traffic) information in association with the session identifier. At 620, the system routes the network traffic to the applicable destination, such as the server or other internet endpoint. At 625, a determination is made as to whether process 600 is complete. In some embodiments, process 600 is determined to be complete in response to a determination that no further network traffic is to be routed/handled, an administrator indicates that process 600 is to be paused or stopped, etc. In response to a determination that process 600 is complete, process 600 ends. In response to a determination that process 600 is not complete, process 600 returns to 605.

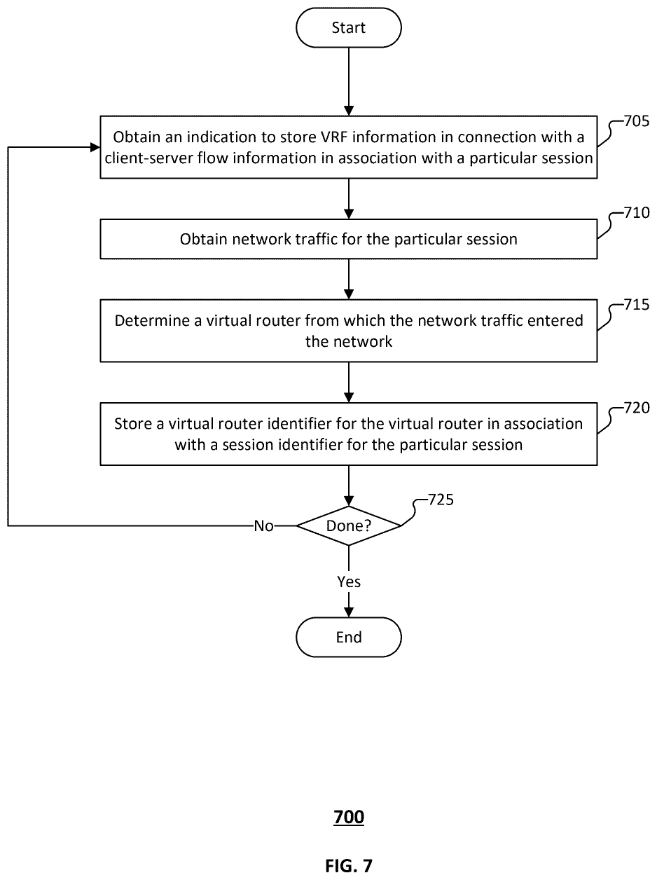

FIG. 7 is a flow diagram of a method for storing virtual router forwarding information in connection with received network traffic according to various embodiments. In some embodiments, process 700 is implemented at least in part by system 100 of FIG. 1 and/or system 200 of FIG. 2.

At 705, the system obtains an indication to store VRF information in connection with a client-server flow information in association with a particular session. At 710, the system obtains network traffic for the particular session. At 715, the system determines a virtual router from which the network traffic entered the network, for example, the virtual router via which the corresponding endpoint (e.g., client system) connected to the network to provide C2S traffic. At 720, the system stores a virtual router identifier for the virtual router in association with a session identifier for the particular session. At 720, a determination is made as to whether process 700 is complete. In some embodiments, process 700 is determined to be complete in response to a determination that no further network traffic is to be routed/handled, no further network traffic sessions are to be initiated, no further virtual router identifier is to be stored in association with a session identifier, an administrator indicates that process 700 is to be paused or stopped, etc. In response to a determination that process 700 is complete, process 700 ends. In response to a determination that process 700 is not complete, process 700 returns to 705.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
store an ingress Virtual Routing and Forwarding (VRF) information in connection with a client-server flow information for a particular session; and
cause network traffic received from a server to be routed based at least in part on the VRF information; and
a memory coupled to the one or more processors and configured to provide the one or more processors with instructions.

2. The system of claim 1, wherein causing the network traffic from the server to be routed based on the VRF information comprises:
performing a lookup of the VRF information stored in association with the particular session to obtain routing information; and
routing the network traffic based at least in part on the routing information.

3. The system of claim 2, wherein the routing information comprises a virtual router ingress interface identifier.

4. The system of claim 3, wherein a next generation firewall (NGFW) obtains the virtual router ingress interface identifier from the client-server flow information and determines, based on performing the lookup, the VRF information associated with the virtual router ingress interface identifier.

5. The system of claim 2, wherein the routing information comprises a port via which a corresponding client is connected to a network edge device.

6. The system of claim 5, wherein the network edge device is a firewall.

7. The system of claim 1, wherein the network traffic is routed by a firewall that provides a service to a plurality of virtual route forwarders, and the firewall supports overlapping an IP address space among at least two of the plurality of the virtual route forwarders.

8. The system of claim 7, wherein the service comprises providing secure internet access.

9. The system of claim 1, wherein storing the ingress VRF information in connection with a client-server flow information for a particular session comprises:
receiving an client-to-server flow of network traffic;
determining a source virtual route forwarder from which the client-to-server flow is received; and
storing source virtual route forwarder information in connection with the particular session.

10. The system of claim 9, wherein the source virtual route forwarder information comprises a source virtual route forwarder identifier.

11. The system of claim 9, wherein the source virtual forwarder corresponds to an interface identifier for a virtual router in a network for which a security platform provides a security service.

12. The system of claim 9, wherein each virtual route forwarded is associated with a unique interface identifier for a particular virtual router.

13. The system of claim 1, wherein client-to-server flows are uniquely identified based at least in part on a source virtual route forwarder identifier for the source virtual route forwarder from which the client-to-server flows are received.

14. The system of claim 1, wherein server-to-client flows are uniquely identified based at least in part on corresponding source network address translation (SNAT) information.

15. The system of claim 1, wherein storing the ingress VRF information in connection with the client-server flow information for the particular session comprises:
in response to receiving a client-to-server flow, storing session information for the client-to-server flow, wherein the session information comprises a tuple that unique identifies a session associated with the client-to-server flow.

16. The system of claim 15, wherein the tuple comprises a source address, a destination address, a source port, a destination port, a protocol, and a security zone.

17. The system of claim 15, wherein the session information comprises a session identifier.

18. The system of claim 1, wherein the session information identifies a flow of traffic from a client to a server and a flow of traffic from the server to the client.

19. The system of claim 1, wherein causing the network traffic from the server to be routed based at least in part on the VRF information comprises:
bypassing a route look up with respect to an internet VRF and performing a route look up with respect to the ingress VRF information obtained from a session lookup.

20. A method, comprising:
storing an ingress Virtual Routing and Forwarding (VRF) information in connection with a client-server flow information for a particular session; and
causing network traffic received from a server to be routed based at least in part on the VRF information.

21. A computer program product embodied in a non-transitory computer readable medium and comprising computer instructions for:
storing an ingress Virtual Routing and Forwarding (VRF) information in connection with a client-server flow information for a particular session; and
causing network traffic received from a server to be routed based at least in part on the VRF information.
